(19) United States
(12) Patent Application Publication
(10) Pub. No.: US 2010/0212094 A1
(43) Pub. Date: Aug. 26, 2010

(54) SANITIZING FLUID DISPENSING DEVICE

(76) Inventor: Jayson Albret Cohen, Boston, GA (US)

Correspondence Address: BRIAN D. BELLAMY, P.O. BOX 1997, THOMASVILLE, GA, 31799-1997, US

(21) Appl. No.: 12/392,781

(22) Filed: Feb. 25, 2009

(51) Int. Cl. B08B 1/00; B08B 7/00

(52) U.S. Cl. 15/104.04; 15/104.92

(57) ABSTRACT

A device and method for dispensing sanitizing fluid via a ring with disjoined ends. The ring flexes to enlarge a gap between the disjoined ends for placement of the device about a shopping cart handle. The ring also flexes to reduce the gap for wiping the shopping cart handle with a moistened wipe that is retained on an inner periphery surface of the ring. The ring includes a refillable cavity forming a reservoir within the body to provide a store of sanitizing fluid that is dispersed through an opening in the inner periphery of the ring onto or through the moistened wipe. The reservoir may be refilled by opening a plug or diaphragm disposed on the outer periphery of the ring and inserting a refill needle.

### BACKGROUND OF THE INVENTION

1. Field of the Invention

The present invention relates to sanitization of surfaces such as handles of carts and baskets, and particularly to a novel fluid dispensing ring for application of a sanitizing agent.

2. Description of the Related Art

It is an everyday occurrence that shopping carts and baskets are used for shopping and especially purchasing groceries. In the typical routine, a shopper grabs a cart and pushes it around throughout the store. The handle used on these carts is tubular and everyone tends to grab the handle at the same location thereon. At most stores, these handles are seldom cleaned. Therefore, germs, micro-organisms, mildew, insects, viruses, disease, drug residue, and other harmful substances are deposited onto the handles by various shoppers throughout the course of time. Only persistent cleaning could avoid contamination of a cart or basket handle, which is logistically not practical without additional expense to consumers through higher prices. As a result, many diseases and substances can be transmitted by physical contact from one to another when using shopping carts and baskets. Young children are especially at risk, as they are placed in a shopping cart seat and can either put their mouths directly on handle, or often put their hands in their mouths after holding onto the handle.

In the past, careful shoppers have used sanitizing wipes to clean off the handle of a shopping cart prior to use. Concern with sanitation of shopping carts has continued to grow to the point that some grocery stores are beginning to provide sanitizing wipes near the storage location of carts for the use of customers. Some stores have gone a step further and will provide a disposable sheath that is designed to cover the unsanitary surface of the cart handle and allow the customer to avoid direct physical contact with the handle surface. And still some stores have even gone so far as to provide means to regularly sanitize the entire cart. For instance, a passageway may be provided having an entrance and an exit and a source of ozinated water or other sanitizing system for spraying the cart.

In yet another effort to provide a sanitizing means for shopping cart handles, U.S. Patent Publication No. 2006/0267299 to Dunser shows a sanitizing apparatus for shopping cart handles and other handles that includes a housing with a fluid reservoir mounted to slidably encircle a cart handle and dispense the fluid onto the handle from applicators in the housing that contact the handle as the housing is moved to and fro. A great disadvantage of the sanitizing apparatus disclosed by Dunser is the lack of portability thereof and the requirement of an external housing and a pump system to disperse fluid onto a spreading surface. This sanitizing apparatus will only be available where installed on the cart handles, without having the option of portability. Thus, the shopper is dependent on the each store to provide a sanitizing system for their shopping cart handles or else provide their own means. While some stores may desire to provide a sanitizing system to consumers, they would desire a solution that is easy to install, simple to maintain and inexpensive. Dunser does not completely address these needs.

Despite the need for sanitizing of shopping cart handles, it is believed that most grocery stores and especially other types of stores do not provide any of these sanitizing means discussed above. Some of the reasons could be expense and maintenance of systems such as Dunser as discussed. Another reason may be indifference by the store operator. As a result, the only reliable method a person has requires carrying a bulky package of sanitizing wipes, and this discourages regular sanitizing of shopping cart handles. Thus, a need exists for a device by which a shopper can provide their own means to sanitize shopping cart handles, and that also provides an improved approach to sanitizing shopping cart handles that will motivate stores to provide a solution to their customers. Such device should be highly portable, compact, effective and, if preferred, disposable. In addition, such devices should be easy for a store to cheaply install on multiple carts.

### SUMMARY OF THE INVENTION

The present invention relates to a sanitizing fluid dispensing device that can fit around common shopping cart handles, and a method for dispensing sanitizing fluid from the device so that the device may be used to as a sanitizing wipe for the handles. The invention allows for the flexible placement of the device about the handle without a person touching the handle so that the handle may be sanitized without physical human contact. The handled is sanitized by movement of the device to and fro and then the device is removed and may be stored in a pocket or purse for reuse.

One embodiment includes a molded circular hollow ring of plastic or any suitable hardened polymer. The ring is of suitable size to fit around a shopping cart handle so that the inner periphery of the ring provides a surface that is proximal to the outer circumferential surface of the handle. The ring is hollow to provide a casing about a cavity that creates a reservoir for storage of sanitizing fluid. The fluid therein may be thickened or in form of a gel to enhance the sanitizing fluid product and prevent leaking. The fluid dispenses from the inner periphery of the ring via a moistened wipe that is incorporated into the inner periphery surface of the body.

In accordance with another aspect of the invention, a gap can be included between ends of the ring so that the ring is not continuous. In addition, the plastic or polymer material may be flexible, at least at certain points along the ring's circumference, so that the ring can accommodate fitting about a shopping cart handle and in another aspect support handles of various size.

In one embodiment of the invention, the reservoir will be filled with sanitizing fluid during construction of the ring, and the ring will be disposable upon becoming empty. In an alternative embodiment of the invention, the reservoir will be filled with sanitizing fluid during or after construction of the ring, and the ring may be refilled upon becoming empty. In this respect, the ring may include a removable plug on the body of the ring for insertion of a needle used to provide a refill of fluid to the reservoir. Alternatively, the ring may include a self-closing diaphragm instead of a plug.

In accordance with another aspect of the invention, the moistened wipe that is in the inner periphery surface of the ring may be a material that is affixed and may transfer fluid via a permeable membrane, a permeable and compressible sponge, or by a material that freely spins and rolls within the ring surface to collect fluid within the reservoir. The moistened wipe material then deposits fluid as it rolls in contact with a handle or is depressed by contact with a handle. Such material may consist of absorbent material or engineered material that collects a determined amount of fluid from the reservoir as deemed sufficient for efficient sanitization of a handle surface. In addition, the material may vary in size and in the distance that the material protrudes from the inner surface of the ring.

These and other aspects, features, and advantages of the present disclosure will be discussed in the further detail below in conjunction with the accompanying drawings.

### BRIEF DESCRIPTION OF THE DRAWINGS

FIG. 1 is a perspective view of a sanitizing ring device constructed in accordance with the teachings of the disclosure and depicted as movable to and fro on a handle.

FIG. 2 is a partial perspective view of the sanitizing ring device with a plug for refilling the sanitizing fluid contained within.

FIG. 3 is a plan view of the device illustrating a means for refill by a needle and flexibility of the device for accommodating a handle.

FIG. 4 is a partial perspective view of the sanitizing ring device with a diaphragm for refilling the sanitizing fluid.

FIG. 5 is an enlarge plan view of the diaphragm in FIG. 4.

### DETAILED DESCRIPTION OF THE DRAWINGS

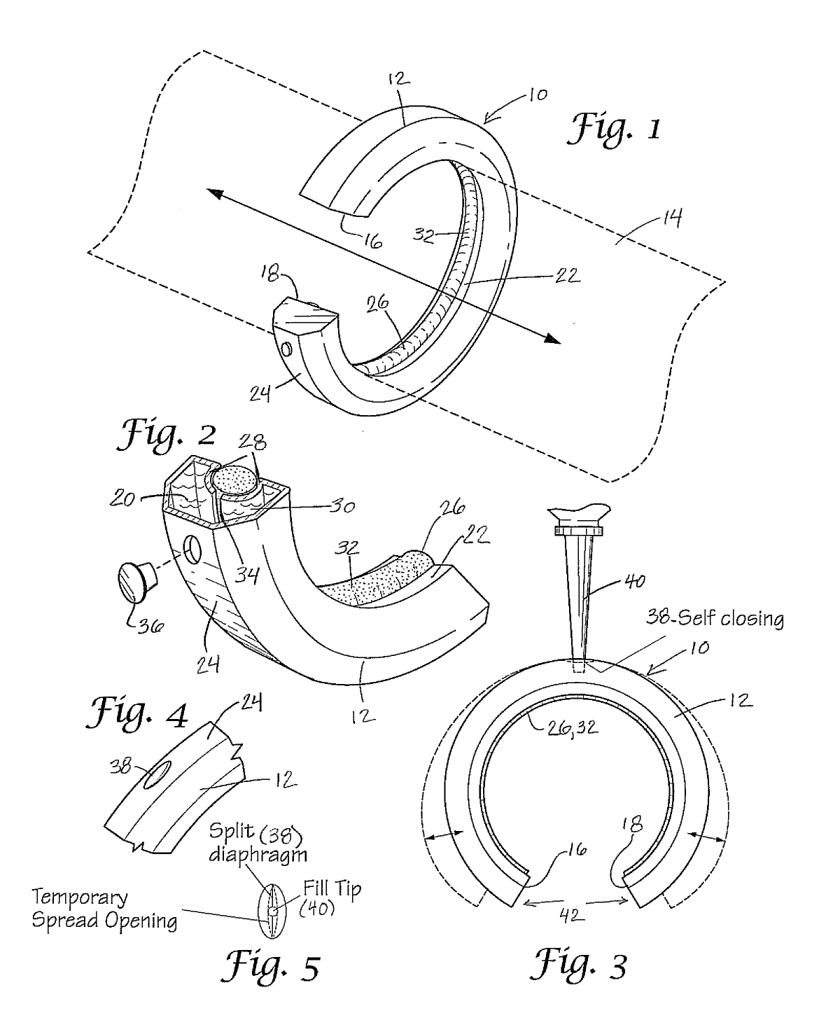

Referring now to the drawings and with specific reference to FIG. 1, a sanitizing ring 10 is shown in which the primary body 12 of the ring is constructed of a plastic or hardened polymer material and the body forms the semi-circular shape of the ring. The body 12 is appropriately sized to fit about typical tubular handles 14 on shopping carts and baskets. The size of the ring 10 is also small enough that it can be stored in a purse or pocket of a person. Further, the body 12 forms a semi-circular ring as shown in that the ring 10 includes a first disjoined end 16 and second disjoined end 18. Each of these disjoined ends is enclosed and provides a solid surface on each of the disjoined ends of the ring. The disjoined ends do not meet unless pushed together and, thus, provide a gap 42 between the disjoined ends 16, 18. The body 12 of the ring will fit about the tubular handle 14 as illustrated by the dashed lines in FIG. 1, and the body will move to and fro as illustrated by the arrows pointing laterally each direction on the handle, whereby the sanitizing ring 10 will deposit a sanitizing fluid 20 onto the handle 14.

The body 12 of the ring 10 is generally round in circumference or may be shaped with flattened sides as shown in the figures. The body 12 includes an inner periphery surface 22 on the inner circumference of the body 12 and an outer periphery surface 24 on the outer circumference of the body. The inner periphery surface 22 retains a moistened wipe 26 for application of fluid 20 to the handle 14 surface. One aspect of the embodiment shown is that the moistened wipe 26 extends about the entire length of the inner periphery surface 22 to maximize the coverage of sanitizing fluid 20 that is deposited during the to and fro movement of the ring 10. The moistened wipe 26 shown in FIGS. 1-2 is a rolling member retained in the inner periphery surface 22 by the shape, size and elasticity of the rolling member, such that the moistened wipe in the particular embodiment naturally remains within the inner circumference of the ring 10. Such rolling member moistened wipe 26 may be constructed of material that will freely spin and roll within a recessed channel 28 provided within the inner periphery surface 22 of the body 10. Such material may collect sanitizing fluid 20 from a reservoir 30 onto the surface of the moistened wipe 26 as the rolling wipe rotates and then deposits the sanitizing fluid on the handle 14 surface, and such material may be absorbent or non-absorbent depending on the material and fluid chosen. Alternatively, the moistened wipe shown could comprise a permeable membrane, compressible sponge, or mechanically retained rollers. The wipe 26 may not necessarily be required to roll within the inner periphery surface depending upon the means for transfer of fluid 20 from the reservoir to the material's contacting surface 32.

Sanitizing fluid 20 may be transferred to the contacting surface 32 of the material through absorption or permeation of the wipe material. Such fluid 20 is transferred to the moistened wipe 26 by several fluid transfer apertures or a narrow slit 34 provided in the inner periphery surface 22 of the body 12 and situated beneath where the moistened wipe is retained on the inner periphery surface. Such apertures or slit 34 are constructed in accordance with the objectives of this invention to transfer a sufficient and desirable amount of fluid to the moistened wipe for sanitizing. However, the apertures or slit 34 are also constructed to minimize waste and maintain the sanitizing fluid 20 within the ring 10 until transfer of the fluid is activated by to and fro motion of the ring.

As shown in FIG. 2, the sanitizing ring body 12 is hollow and includes a cavity providing a reservoir 30 for holding the sanitizing fluid 20. The sanitizing fluid 20 may be prefilled into the reservoir 30 during manufacture, and the device may be disposed of when the reservoir is empty upon the application of all fluid. Alternatively, as shown, the reservoir 30 may be filled or refilled with sanitizing fluid 20 after manufacture by providing access to the cavity in the body 12. Such access may be provided by a replaceable plug 36 in the outer periphery surface of the body as shown in FIG. 2 or a diaphragm 38 in the outer periphery surface as shown in FIGS. 4-5. Regardless, the sanitizing fluid 20 may be disposed within the reservoir 30 by inserting a needle 40 as shown in FIG. 3 and dispensing the fluid into the reservoir until full. When using a plug 36, the plug is removed for insertion of the needle 40 and replaced upon filling. Whereas, when using a diaphragm 38, the needle 40 is inserted into a split in the diaphragm to spread open the diaphragm temporarily using the needle. Once the needle is removed, the diaphragm 38 closes as shown in FIG. 4.

FIG. 3 further illustrates that the plastic or hardened polymer body 12 is flexible in the embodiment shown, so that the first disjoined end 16 and second disjoined end 18 of the body may be bent away from each other. Through bending the disjoined ends away from each other, a gap 42 between the disjoined ends 16, 18 enlarges for receiving a handle 14. Additionally, the flexibility of the body 12 allows the disjoined ends of the body to be bent inward toward each other to decrease the circumference of the ring 10 and the inner periphery surface of the body. The ring 10 may be closed by bending the body 12 and moving the disjoined ends 16, 18 toward each other until the inner periphery surface of the body is in contact with the handle for disposition of sanitizing fluid 20 from the ring.

Thus, the device provides a method of sanitizing shopping cart handles and the like by providing a portable sanitizing ring 10 with a unitary body constructed of inexpensive plastic. The portable ring provides a person with a readily available supply of a sanitizing fluid 20 without the person having to carry bulky sanitizing wipes. Further, the portable ring 10 provides a person with a simple means for depositing the sanitizing fluid 20 onto the surface of a handle 14 without needing a wipe by placing the sanitizing ring 10 about the handle by bending the ring to expand a gap 42 between the disjoined ends 16, 18 for receiving the handle. Then, the person simply closes the sanitizing ring 10 about the handle 14 by bending the ring to close the gap 42 between the disjoined ends 16, 18, and he or she moves the sanitizing ring to and fro on the handle to deposit sanitizing fluid 20 on the handle. The sanitizing ring 10 is removed from the handle 14 by bending the ring to expand the gap 42 between the disjoined ends 16, 18 for removing from the handle. The person can store the sanitizing ring 10 for future use. Conveniently, such storage may be in his or her pocket or purse.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

I claim:

1. A device for dispensing sanitizing fluid comprising:
a body forming a ring with disjoined ends that provide a gap between the disjoined ends, and the body being flexible for movement of the disjoined ends by bending the body to enlarge or reduce the gap;
the body having an interior cavity within the ring forming a reservoir within the body for containing a sanitizing fluid;
the body having an exterior surface providing an outer periphery surface and an inner periphery surface on the ring;
the inner periphery surface including an opening therein for transfer of sanitizing fluid from the reservoir; and
a moistened wipe retained on the inner periphery surface from disposition of sanitizing fluid transferred from the reservoir onto a handle surface.

2. A device for dispensing sanitizing fluid as in claim 1 in which said inner periphery surface includes a recessed channel, said opening is a slit about the entire inner periphery, and said moistened wipe is a rolling member retained within the recessed channel.

3. A device for dispensing sanitizing fluid as in claim 1 in which said body includes a plug or diaphragm disposed in said outer periphery surface for insertion of a needle for filling the reservoir.

4. A method for sanitizing a handle comprising:
providing a portable sanitizing ring with disjoined ends and a reservoir of sanitizing fluid contained therein;
placing the sanitizing ring about the handle by bending the ring to expand a gap between the disjoined ends for receiving the handle;
closing the sanitizing ring about the handle by bending the ring to close the gap between the disjoined ends;
moving the sanitizing ring to and fro on the handle to deposit sanitizing fluid on the handle;
removing the sanitizing ring from the handle by bending the ring to expand the gap between the disjoined ends for removing from the handle; and
storing the sanitizing ring with one's person for future use.
